(19) United States
(12) Patent Application Publication
(10) Pub. No.: US 2018/0294083 A1
(43) Pub. Date: Oct. 11, 2018

(54) COMPOSITION FOR PRODUCING MAGNETIC CORES AND A PROCESS FOR PRODUCING THE COMPOSITION

(71) Applicant: BASF SE, Ludwigshafen am Rhein (DE)

(72) Inventors: Herve DIETSCH, Bad Dürkheim (DE); Reinhard ZICKGRAF, Waldsee (DE); Frank PRISSOK, Lemförde (DE); Jae Hyung HWANG, Viernheim (DE); Oliver KOCH, Wachenheim (DE); Gaurav KASALIWAL, Dombivli (East) (IN)

(21) Appl. No.: 15/576,929

(22) PCT Filed: May 19, 2016
(86) PCT No.: PCT/EP2016/061231

§ 371 Date: Nov. 27, 2017

(30) Foreign Application Priority Data
May 27, 2015 (EP) 15169443.7

(51) Int. Cl. H01F 1/147; B22F 1/00; C08J 3/20

(52) U.S. Cl. CPC H01F 1/14791; H01F 1/14766; H01F 3/08; C08J 3/201; B22F 1/0062

(57) ABSTRACT

The invention relates to a composition for producing magnetic cores comprising 90 to 95% by weight of a soft magnetic powder and 5 to 10% by weight of a polymer matrix material, each based on the mass of the composition, wherein the polymer matrix material comprises 50 to 0% by weight of a thermoplastic polyurethane based on the mass of the polymer. The invention further relates to a process for producing the composition and a magnetic core made of the composition.

The invention relates to a composition for producing magnetic cores comprising a soft magnetic powder and a polymer matrix material. The invention further relates to a process for producing the composition.

Magnetic cores serve for example as piece of magnetic material with a high permeability used to confine and guide magnetic fields in electrical, electromechanical and magnetic devices such as electromagnets, transformers, electric motors, inductors and magnetic assemblies. These components are usually produced in different shapes and sizes by molding soft-magnetic powder in a die under high pressure.

In electronic applications, particularly in alternating current (AC) applications, the two key characteristics of the magnetic core component are the magnetic permeability and the core loss characteristic. In this context, the magnetic permeability of a material provides an indication of its ability to become magnetized or its ability to carry a magnetic flux. Permeability is defined as the ratio of the induced magnetic flux to the magnetizing force or field intensity. When a magnetic material is exposed to a rapidly varying field, the total energy of the core is reduced by the occurrence of hysteresis losses and/or eddy current losses. The hysteresis loss is caused by the necessary expenditure of energy to overcome the retained magnetic forces within the core component. The eddy current loss is caused by the production of electric currents in the core component due to the changing flux caused by AC conditions and basically results in a resistive loss.

Generally, devices for high frequency applications are sensitive to core losses and in order to reduce losses due to eddy currents good insulation of the soft-magnetic powder particles is desired. The simplest way of achieving this is thickening an insulating layer for each particle. However, the thicker the insulation layer is, the lower the core density of soft-magnetic particles gets and the magnetic flux density decreases. Furthermore, an attempt to increase the magnetic flux density by compression-molding under high pressure may lead to larger strain in the core and, hence, to a higher hysteresis loss.

In order to manufacture a core comprising a soft-magnetic powder having optimal key characteristics, it is necessary to increase the resistivity and the density of the core simultaneously. For this reason, particles would ideally be covered with a thin insulating layer having a high insulating property. In the field of magnetic powders different approaches to this problem exist.

WO-A 2007/084363 relates to a method for preparing metallurgical powder compositions and compacted articles made thereof. The metallurgical powder composition comprises a base-metal powder, which is at least partially coated by metal phosphate and a particulate internal lubricant. The internal lubricants used include, for example, polyamides, C₅ to C₃₀ fatty acids, metal salts of polyamides, metal salts of C₅ to C₃₀ fatty acids, ammonium salts of C₅ to C₃₀ fatty acids, lithium stearate, zinc stearate, manganese stearate, calcium stearate, ethylene bis-stearamide, polyethylene waxes, polyolefins, and combinations thereof. Through the combination of phosphate coating and internal lubricant the lubricity of the metal particles and the compacted parts can be increased, while reducing the amount of organic compounds present.

EP-B 0 810 615 describes a soft-magnetic powder composite core which comprises particles with insulating layers. In particular, the soft-magnetic particles are treated by a solution comprising a phosphating solution, which comprises a solvent and phosphate salts. Additionally, the solution comprises a surfactant and a rust inhibitor which is an organic compound containing nitrogen and/or sulfur having a lone pair of electrons suppressing the formation of iron oxide.

EP-B 0 765 199 discloses admixing powder compositions of iron-based particles with a thermoplastic material an d a lubricant selected from the group consisting of stearates, waxes, paraffins, natural and synthetic fat derivatives and oligomers of polyamide type. The obtained mixture is compacted at a temperature below the glass-transition temperature or melting point of the thermoplastic resin and the compacted product is heated in order to cure the thermoplastic resin. With the lubricant added to the thermoplastic material the process is less time consuming, but an essential improvement in the soft magnetic properties cannot be reached.

Compositions comprising a soft magnetic powder and a polymer matrix material are also described for example in EP-A 0 264 287, EP-A 0 534 744, U.S. Pat. No. 6,451,221, EP-A 0 554 009 or DE-A 10 2011 010757.

Known processes for forming insulating layers on magnetic particles typically tackle one of the key characteristics, i.e. the density or the insulation properties, while keeping the other constant. Therefore, the resistivity and magnetic permeability obtainable are limited. Hence, there is still a need in the art to further improve the process of treating soft-magnetic powders in order to reach optimal results for magnetic core components prepared from such powders.

Therefore it is an object of the present invention to provide a composition for producing magnetic cores, which show high resistivity, high permeability and are non-corrosive. Further, the composition shall be processable using classical methods used for polymer materials such as injection moulding. Further, it is an object of the present invention to provide a process for producing the composition and to provide a magnetic core which requires no further corrosion protection and shows high magnetic properties and a sufficient flexibility and low brittleness to be stable for use in electronic applications.

These objects are achieved by a composition for producing magnetic cores comprising 90 to 95% by weight of a soft magnetic powder and 5 to 10% by weight of a polymer matrix material, each based on the mass of the composition, wherein the polymer matrix material comprises 50 to 100% by weight of a thermoplastic polyurethane based on the mass of the polymer.

Further, these objects are achieved by a process for producing the composition, comprising
(a) melting the polymer matrix material and mixing the soft magnetic powder and the melted polymer matrix material in a kneader or an extruder,
(b) pressing the mixture of the soft magnetic powder and the polymer matrix material through a die to form strands by means of an extruder and cutting the strands into pellets.

Finally, these objects are achieved by a magnetic core made of the composition, wherein the magnetic core has a tensile strength in the range from 0.5 MPa to 50 MPa and a modulus of elasticity in the range from 0.2 MPa to 1 MPa.

To achieve sufficient magnetic properties for several applications it is necessary that the amount of the soft magnetic particles is greater than 90% by weight. Further, with an increasing amount of soft magnetic particles the magnetic properties also get better. On the other hand, an increasing amount of polymer material results in an inferior flexibility and higher brittleness which makes the magnetic cores less stable.

It has been shown that magnetic cores made from the inventive composition comprising 90 to 95% by weight of soft magnetic powder and 5 to 10% by weight of a polymer matrix material, wherein the polymer matrix material comprises at least 50% by weight based on the total amount of polymer matrix material have sufficient magnetic properties and additionally a sufficient flexibility and low brittleness.

Particularly for use in wireless loading stations it is necessary that the magnetic core shows good breaking resistance. Magnetic cores made of the inventive composition even fulfil the needs regarding flexibility and low brittleness for use in wireless loading stations.

The polymer matrix material of the inventive composition comprises 50 to 100% by weight of a thermoplastic polyurethane. Preferably, the amount of thermoplastic polyurethane is 90 to 100% by weight and in a particularly preferred embodiment, the amount of thermoplastic polyurethane is 100% by weight.

A thermoplastic polyurethane is each polyurethane which shows thermoplastic properties. Thermoplastic properties in this context are that the polymer can be repeatedly melted by heating and shows plastic flow while in melted condition.

In the context of this invention, thermoplastic polyurethanes are all known polyaddition products of polyisocyanates.

The thermoplastic polyurethane preferably is composed of:
(i) an aliphatic, cycloaliphatic, araliphatic or aromatic diisocyanate,
(ii) at least one high-molecular compound having hydroxy groups reactive versus isocyanates,
(iii) optionally an antistatic additive,
(iv) optionally at least one catalyst,
(v) optionally low molecular chain extenders.

Suitable cycloaliphatic or aromatic diisocyanates are for example 2,4-toluylene-diisocyanate; mixtures of 2,4-toluylene-diisocyanate and 2,6-toluylene-diisocyanate; 4,4′-diphenyl methane diisocyanate, 2,4′-diphenyl methane diisocyanate, 2,2′-diphenyl methane diisocyanate and their mixtures; mixtures of 2,4′-diphenyl methane diisocyanate and 4,4′-diphenyl methane diisocyanate; urethane-modified liquid 4,4′-diphenyl methane diisocyanate and/or 2,4′-diphenyl methane diisocyanate; 4,4′-diisocyanato diphenylethane-1,2 and 1,5-naphthylene diisocyanate.

Suitable aliphatic or cycloaliphatic diisocyanates are for example tri-methylene diisocyanate, tetra-methylene diisocyanate, penta-methylene diisocyanate, hexa-methylene diisocyanate, hepta-methylene diisocyanate, octa-methylene diisocyanate, 2-methyl pentamethylene diisocyanate-1,5, 2-ethyl butylene diisocyanate-1,4, 1-isocyanato-3,3,5-trimethyl-5-isocyanatomethyl cyclohexane (isophorone diisocyanate, IPDI), 1,4-bis(isocyanatomethyl)cyclohexane, 1,3-bis(isocyanatomethyl)cyclohexane, 1,4-cyclohexane diisocyanate, 1-methyl-2,4-cyclohexane diisocyanate, 1-methyl-2,6-cyclohexane diisocyanate, 4,4′-dicyclohexylmethane diisocyanate, 2,4′-dicyclohexylmethane diisocyanate, 2,2′-dicyclohexylmethane diisocyanate, or mixtures thereof.

Particularly preferred diisocyanates are hexamethylene-1,6-diisocyanate, 4,4′-diphenyl methane diisocyanate, 2,4′-diphenyl methane diisocyanate, 2,2′-diphenyl methane diisocyanate and their mixtures.

High-molecular compounds having hydrogen atoms reactive versus isocyanates are for example polyesterols, polyetherols and/or polycarbonatediols, which are summed up by the term “polyols”.

The number average molecular weight of the polyol preferably is in the range from 500 to 8000, more preferred in the range from 600 to 6000 and particularly in the range from 800 to 3000. The average functionality versus isocyanates of the polyol preferably is in a range from 1.8 to 2.3, more preferred in a range from 1.9 to 2.2 and particularly 2.

Suitable polyetherols are for example such being based on known starting substances and common alkylene oxides, for example ethylene oxide, propylene oxide and/or butylene oxide.

Particularly preferred are polyetherols based on propylene oxide-1,2 and ethylene oxide. Preferred polyetherols are for example polyoxytetramethylene glycols.

Suitable polyesterols generally are polyesters based on diacids and diols. The diols are preferably such having 2 to 10 carbon atoms, for example ethanediol, butanediol, hexanediol, or mixtures thereof. Particularly preferred is 1,4-butanediol. Diacids can be all known diacids, for example linear or branched diacids having 4 to 12 carbon atoms and mixtures of at least two different diacids. Particularly preferred as a diacid is adipic acid.

Preferred antistatic additives (iii) comprise ethylmethylimidazole ethyl sulfate. Ethylmethylimidazole ethyl sulfate can be used here alone or in a mixture, for example together with other antistatic additives. Particularly preferred, ethylmethylimidazole ethyl sulfate is used as sole antistatic additive. The content of ethylmethylimidazole ethyl sulfate, based on the total weight of components (i) to (v), is usually from 0.001 to 30% by weight, particularly preferably from 0.1 to 5% by weight. It is likewise possible to use the antistatic additive (iii) in the form of an active-ingredient concentrate. This active-ingredient concentrate comprises by way of example from 30 to 80% by weight of ethylmethylimidazole ethyl sulfate and from 70 to 20% by weight of thermoplastic polyurethane.

Suitable catalysts (iv) which in particular accelerate the reaction between the NCO groups of the diisocyanates (i) and the hydroxy groups of the structural components (ii) and optionally the low molecular chain extenders (v) are for example tertiary amines which are conventional and known from the prior art, e. g. triethylamine, dimethylcyclohexylamine, N-methylmorpholine, N,N′-dimethylpiperazine, 2-(dimethylaminoethoxy)ethanol, diazabicyclo[2.2.2]octane, and the like. Further suitable and particularly preferred catalysts are organometallic compounds, such as titanic esters, iron compounds, e. g. ferric acetylacetonate, tin compounds, e. g. stannous diacetate, stannous dioctoate, stannous dilaurate, or the dialkyltin salts of aliphatic carboxylic acids, e. g. dibutyltin diacetate, dibutyltin dilaurate, or the like. The amounts usually used of the catalysts are from 0.0001 to 0.1 parts by weight per 100 parts by weight of polyhydroxy compound (ii).

Low molecular chain extenders and crosslinkers can be either hydroxyl compounds with:
a) difunctional molecules such as ethylene glycol, diethylene glycol, triethylene glycol, tetra-ethylene glycol, propylene glycol, dipropylene glycol, tripropylene glycol, 1,3-propanediol, 1,3-butanediol, 1,4-butanediol, neopentyl glycol, 1,6-hexanediol, 1,4-Cyclohexanedimethanol, HQEE, ethanolamine, diethanolamine, methyldiethanolamine, phenyldiethanolamine, diethyltoluenediamine, dimethythiotoluenediamine;
b) trifunctional molecules such as glycerol, trimethylolpropane, 1,2,6-hexanetriol triethanolamine;
c) tetrafunctional molecules such as pentaerythritol, N,N,N′N′-tetrakis(2-hydroxypropyl)-ethylenediamine,

or any combination of these compounds.

Preferably, chain extenders (v) are used for the production of the thermoplastic polyurethane, too.

In order to adjust the hardness of the thermoplastic polyurethane, the components (ii) and (v) can vary in relatively broad molar ratios. Molar ratios of compound (ii) to the total chain extenders to be used (v) from 10:1 to 1:10, have achieved good results. Particularly from 1:1 to 1:4, the hardness of the thermoplastic polyurethane increases with a higher degree of (v).

The implementation can take place at the usual characteristic numbers, preferably with a characteristic number from 80 to 110. The characteristic number is defined by the ratio of the total isocynate groups used for the implementation of component (i) to the groups reactive with isocyanate, i.e. the active hydrogens, of the components (ii) and (v). At a characteristic number of 100 there is one active hydrogen atom per isocyanate group of component (i), i.e. one function reactive towards isocyanates, of components (ii) and (v). At characteristic numbers above 100 more isocyanate groups than OH-groups are present.

If the polymer matrix material is a polymer blend comprising the thermoplastic polyurethane and additionally at least one further polymer, the further polymer also is a thermoplastic polymer and preferably one or more of polyethylene, polypropylene, polyester, polyether, polystyrene, polycarbonate, polyvinyl chloride, acrylonitrile-butadiene-styrene copolymers, acrylic ester-styrene-acrylonitrile copolymers, styrene-acrylonitrile copolymers, polyacrylonitrile, ethylene vinyl acetate, polybutylene terephthalate, polyethylene terephthalate and polyoxymethylene.

A soft-magnetic powder of the present invention includes a plurality of particles composed of a soft-magnetic material. Such powders comprise particles with a mean size between 0.5 and 250 μm, preferably between 2 and 150 μm, more preferably between 2 and 10 μm. These particles may vary in shape. In respect of the shape, numerous variants known to the person skilled in the art are possible. The shape of the powder particles may, for example, be needle-shaped, cylindrical, plate-shaped, teardrop-shaped, flattened or spherical. Soft-magnetic particles with various particle shapes are commercially available. Preferred is a spherical shape as such particles can be coated more easily, which in fact results in a more effective insulation against electrical current.

As soft-magnetic material an elemental metal, an alloy or a mixture of one or more elemental metal(s) with one or more alloy(s) may be employed. Typical elemental metals comprise Fe, Co and Ni. Alloys may include Fe-based alloys, such as Fe—Si alloy, Fe—Si—Cr alloy, Fe—Si—Ni—Cr alloy, Fe—Si—B—Cr alloy, Fe—Si—B—Cr—C alloy, Fe—Al alloy, Fe—N alloy, Fe—Ni alloy, Fe—C alloy, Fe—B alloy, Fe—Co alloy, Fe—P alloy, Fe—Ni—Co alloy, Fe—Cr alloy, Fe—Mn alloy, Fe—Al—Si alloy and ferrites, or rare earth based alloy, particularly rare earth Fe-based alloy, such as Nd—Fe—B alloy, Sn—Fe—N alloy, Sm—Co alloy, Sm—Co—Fe—Cu—Zr alloy and Sr-ferrite. In a preferred embodiment Fe or Fe-based alloys, such as Fe—Si—Cr, Fe—Si, Fe—Si—Al—B, Fe—Si—Al—P, Fe—Si—Al—B—P or Fe—Al—Si, serve as soft-magnetic material.

In a particularly preferred embodiment Fe serves as soft-magnetic material and the soft-magnetic powder is a carbonyl iron powder. Carbonyl iron can be obtained according to known processes by thermal decomposition of iron pentacarbonyl in a gas phase, as described, for example, in Ullmann's Encyclopedia of Industrial Chemistry, 5th Edition, Vol. A 14, page 599 or in DE 3 428 121 or in DE 3 940 347, and contains particularly pure metallic iron.

Carbonyl iron powder is a grey, finely divided powder of metallic iron having a low content of secondary constituents and consisting essentially of spherical particles having a mean particle diameter of up to 10 μm. Unreduced carbonyl iron powder, which is preferred in the present context, has an iron content of >97% by weight (here based on the total weight of the powder), a carbon content of <1.5% by weight, a nitrogen content of <1.5% by weight and an oxygen content of <1.5% by weight. Reduced carbonyl iron powder, which is particularly preferred in the process of the present invention, has an iron content of >99.5% by weight (here based on the total weight of the powder), a carbon content of <0.1% by weight, a nitrogen content of <0.01% by weight and an oxygen content of <0.5% by weight. The mean diameter of the powder particles is preferably from 1 to 10 μm and their specific surface area (BET of the powder particles) is preferably from 0.2 to 2.5 m²/g.

In a further embodiment of the invention the soft-magnetic powder is pre-treated, preferably phosphated. Phosphating may include coating the soft-magnetic material with an insulating amorphous compound, such as phosphoric acid or salts thereof with at least one element selected from the group consisting of Al, Si, Mg, Y, Ca, B, Zr, and Fe. Since these materials provide reasonably good insulation properties and sufficiently couple a metal to an organic compound, they are particularly suitable for pre-treating particles of the soft-magnetic powder. Furthermore, phosphate carbonyl iron powder can also be further modified by adding inhibitors such as oleyl-imidazole and oleyl-sarcosine.

To produce the inventive composition, in a first step the polymer matrix material is melted and the soft magnetic powder and the melted polymer matrix material are mixed in a kneader or an extruder. In a second step, the mixture comprising the soft magnetic powder and the polymer matrix material obtained in the first step is pressed through a die to form strands by means of an extruder and cutting the strands into pellets.

In a first embodiment of the process for producing the inventive composition, a first apparatus is used to melt the polymer matrix material and the melted polymer matrix material and the soft magnetic powder are fed into the extruder or kneader for mixing. As apparatus for melting the polymer matrix material for example an extruder can be used. Using a separate apparatus for melting the polymer matrix material is particularly preferred when a kneader is used for mixing the polymer matrix material and the soft magnetic powder.

In a second embodiment of the process, melting of the polymer matrix material and mixing of the polymer matrix material and the soft magnetic powder take place in the same apparatus. In this case it is preferred to use an extruder. A suitable extruder is preferably designed such that it comprises a feeding zone into which the polymer matrix material is fed. In a metering zone following the feeding zone, the polymer matrix material is melted. In a further zone the soft magnetic powder is added via a feeding port on the extruder and mixed into the melted polymer matrix material. This mixture can be withdrawn from the extruder and fed into a second extruder to form strands and cut them into pellets. However, in a preferred embodiment, the mixture is pressed through a die of the same extruder in which the polymer matrix material and the soft magnetic powder are mixed and cut into pellets. In this embodiment steps (a) and (b) of the process are performed in one extruder.

The temperature for melting the polymer matrix material and the pressure with which the mixture is pressed through the die are such as generally set in extrusion processes.

The extruder can be any extruder known to a skilled person. Suitable extruders are for example single screw extruders or twin screw extruders.

The pellets produced by this process can be used to form electronic components, particularly magnetic core components as used in electrical, electro-mechanical and magnetic devices such as electromagnets, transformers, electric motors, inductors and magnetic assemblies. Further uses of the coated soft-magnetic powder include manufacture of Radio-Frequency Identification (RFID) tags and for reflecting or shielding electromagnetic radiation.

Lastly, electronic components manufactured based on soft magnetic powder composite may be used for shielding electronic devices. In such applications, alternating magnetic field of the radiation causes the powder particles to continuously rearrange themselves. Due to the resulting friction, the powder particles convert the energy of the electromagnetic waves into heat.

In a particular preferred embodiment, the magnetic core produced from the inventive composition is used as a magnetic core in a wireless loading station.

### EXAMPLES

### Example 1

### Preparation of the Composition

A composition of 10% by weight of a thermoplastic polyurethane based on polytetrahydrofuran (polyTHF) of different molecular weights; mixtures of methylene diphenyl diisocyanate (MDI) and 1,4 butanediol as chain extender and 90% by weight of carbonyl iron powder (CIP) has been prepared using a twin screw extruder having a screw diameter of 30 mm and a L/D ratio of 40. The extruder has been divided into 12 zones of identical length.

The thermoplastic polyurethane has been fed into the first zone of the extruder. The carbonyl iron powder has been fed via one or more side feeders into the 2^{nd}, 3^{rd}, or 4^{th} zone.

The process parameters are shown in table 1.

TABLE 1

| | | | | | Total | CIP |
|---|---|---|---|---|---|---|
| | | | | Screw | through- | through- |
| Temperature (° C.) | | | | speed | put | put |
| Zone 1 | Zones 2-4 | Zones 5-7 | Zones 8-12 | (rpm) | (kg/h) | (kg/h) |
| 30 | 170-190 | 200 | 205 | 225 | 25 | 22.75 |

The produced strands were subjected to hot cut by applying a die face knife pelletizer or the strands were collected and cooled on a rolling metal band and subjected to granulation. The granulation was carried out either by cutting the cooled strands or by grinding the strands into granules.

### Example 2

A composition of the same components as in example 1 and using the same machinery as in example 1 has been produced, however, the process parameters have been set to those as shown in table 2. The polyurethane has been fed through the main feeder and the CIP through one or more side feeders.

TABLE 2

| | | | | | Total | CIP |
|---|---|---|---|---|---|---|
| | | | | Screw | through- | through- |
| Temperature (° C.) | | | | speed | put | put |
| Zone 1 | Zones 2-4 | Zones 5-7 | Zones 8-12 | (rpm) | (kg/h) | (kg/h) |
| 30 | 170-190 | 200 | 205 | 175 | 25 | 23.125 |

### Example 3

A composition of the same components as in example 1 and using the same machinery as in example 1 has been produced, however, the process parameters have been set to those as shown in table 3. The polyurethane has been fed through the main feeder and the CIP through one or more side feeders.

TABLE 3

| | | | | | Total | CIP |
|---|---|---|---|---|---|---|
| | | | | Screw | through- | through |
| Temperature (° C.) | | | | speed | put | put |
| Zone 1 | Zones 2-4 | Zones 5-7 | Zones 8-12 | (rpm) | (kg/h) | (kg/h) |
| 30 | 170-190 | 190 | 200 | 200 | 25 | 23.25 |

### Example 4

The process of example 3 has been repeated, however, all components have been fed through the main feeder.

1.-13. (canceled)

14. A composition for producing magnetic cores comprising 90 to 95% by weight of a soft magnetic powder and 5 to 10% by weight of a polymer matrix material, each based on the mass of the composition, wherein the polymer matrix material comprises 50 to 100% by weight of a thermoplastic polyurethane based on the mass of the polymer.

15. The composition according to claim 14, wherein the polymer matrix material comprises 100% by weight of a thermoplastic polyurethane.

16. The composition according to claim 14, wherein the polymer matrix material is a blend of polyurethane and one or more of polyethylene, polypropylene, polyester, polyether, polystyrene, polycarbonate, polyvinyl chloride, acrylonitrile-butadiene-styrene copolymers, acrylic ester-styrene-acrylonitrile copolymers, styrene-acrylonitrile copolymers, polyacrylonitrile, ethylene vinyl acetate, polybutylene terephthalate. polyethylene terephthalate and polyoxymethylene.

17. The composition according to claim 14, wherein the polyurethane is composed of:
(i) an aliphatic, cycloaliphatic, araliphatic or aromatic diisocyanate,
(ii) at least one high-molecular compound having hydrogen atoms reactive versus isocyanates,
(iii) an antistatic additive,
(iv) optionally at least one catalyst,
(v) optionally low molecular chain extenders.

18. The composition according to claim 17, wherein the high-molecular compound having hydrogen atoms reactive versus isocyanates is a polyol.

19. The composition according to claim 18, wherein the polyol has a number average molecular weight in the range from 500 to 8000 and an average functionality versus isocyanates of 1.8 to 2.3.

20. The composition according to claim 17, wherein the antistatic additive comprises ethylmethylimidazole ethyl sulfate.

21. The composition according to claim 14, wherein the soft magnetic powder comprises carbonyl iron powder, Fe—Si, Fe—Si—Cr, Fe—Si—Al, Fe—Si—Al—B, Fe—Si—Al—P, Fe—Si—Al—B—P.

22. A process for producing the composition according to claim 14, comprising
(a) melting the polymer matrix material and mixing the soft magnetic powder and the melted polymer matrix material in a kneader or an extruder,
(b) pressing the mixture of the soft magnetic powder and the polymer matrix material through a die to form strands by means of an extruder and cutting the strands into pellets.

23. The process according to claim 22, wherein the melting of the polymer matrix material and the mixing of the soft magnetic powder and the melted polymer matrix material take place in the same apparatus.

24. The process according to claim 22, wherein steps (a) and (b) are performed in one extruder.

25. A magnetic core made of the composition according to claim 14, wherein the magnetic core has a tensile strength in the range from 0.5 MPa to 50 MPa and a modulus of elasticity in the range from 0.2 MPa to 1 MPa.

26. The magnetic core according to claim 25, wherein the magnetic core is a magnetic core in a wireless loading station.
